(19) United States
(12) Patent Application Publication
(10) Pub. No.: US 2003/0055196 A1
(43) Pub. Date: Mar. 20, 2003

(54) Release composition and related method of use

(76) Inventors: John R. Strobridge, Comstock Park, MI (US); Michael L. Butcher, Alto, MI (US)

Correspondence Address: Warner Norcross & Judd LLP, 900 Fifth Third Center, 111 Lyon Street, N.W., Grand Rapids, MI, 49503-2489, US

(21) Appl. No.: 10/251,253

(22) Filed: Sep. 20, 2002

Related U.S. Application Data
(60) Provisional application No. 60/323,756, filed on Sep. 20, 2001.

(51) Int. Cl. C08G 77/04; B29C 33/58; B29C 33/60

(52) U.S. Cl. 528/25; 264/338; 264/233

(57) ABSTRACT

A release composition for facilitating removal of shaped articles from a shaping surface. In one embodiment the release composition includes a water-soluble, no-cure dimethicone copolyol. The dimethicone copolyol may include polyoxyethylene and/or polyoxypropylene side chains. The composition is coated on a mold or mandrel surface and or the article and the article and surface is heated to shape the article. The composition prevents the article from adhering to the surface during heating, and thus prevents damage to the when the article is removed from the surface. Because the composition is water-soluble, it is easily washed from the article with water.

### BACKGROUND OF THE INVENTION

This application claims benefit from U.S. Provisional Patent Application No. 60/323,756, filed Sep. 20, 2001.

The present invention relates to shaping articles, and more particularly to compositions applied to shape-determining surfaces to facilitate release of shaped articles from the surfaces.

Many products are molded or shaped from a standard shape to a desired configuration that is specific for the intended use of the product. For example, in the rubber industry, many products, such as hoses, wiper blades, squeegees and moldings are shaped to a final configuration from continuous, linear rubber extrusions. Methods for shaping such products generally includes the use of a molds and/or a mandrel.

In one method used to shape, for example, an automotive radiator hose, a partially cured linear hose extrusion is positioned on a mandrel by sliding the bore of the hose over the mandrel. The mandrel provides an internal shape for the hose. The hose then is heated for a sufficient time and temperature to vulcanize (i.e., cure) the hose such that it retains the shape of the mandrel after removal therefrom.

Removal of shaped rubber items from mandrels and/or molds is often aggravated by adhesion of the shaped rubber article to the shaping surfaces of the mold/mandrel. Accordingly, the shaping surfaces of the mandrel are coated with a material, called a release agent, to form a relatively non-adhesive second surface over the mandrel that facilitates removal of the article.

The release agents are specifically designed to cure on and adhere well to the surface of the mandrel to endure repeated shaping of many articles. It is believed that with such durable coatings, a time savings is realized because the mold surfaces need not be frequently recoated. U.S. Pat. No. 5,601,641 to Stephens discloses such a release agent, which is designed to coat a mold surface and endure more than 20 releases of products from the mold. The Stephens release agent, however, endures so well on the mold surface that after its useful life, it must be sandblasted from the mold. Additionally, due to its specific silicone compounds, the release agent must be cured on the mold with extreme temperatures for about period of time before contacting an article. Moreover, the mold must be degreased before the release agent is reapplied so that the release agent sticks well to the mold for subsequent molding. These extra steps increase production time and reduce output.

Another release agent, disclosed in U.S. Pat. No. 4,534,928 to Martin, also is designed to coat a mold surface and endure multiple moldings. However, due to the inclusion of organic solvents in the agent, it is susceptible to premature curing in moist environments. Thus, the agent must be substantially water-free. Moreover, the specific polydimethylsiloxanes and alkoxysilanes of the agent must be cured with an metal alkoxide accelerator. Finally, the Martin release agent must also be cured for a period of time (20-30 minutes) before molding.

Although the release agents of the prior art and their methods of use facilitate release of articles from molds, they suffer a number of shortcomings. First, the agents must be cured directly on the mold surface at a particular temperature for a period of time before molding. This, in turn, reduces shaping time. Second, the agents are cured so well on the mold surface that, after their useful life, removal from the mold requires substantial effort and expenditure of many man hours. Third, the specific silicone compounds used therein are difficult to clean from molds without special solvents. Fourth, the agents include multiple ingredients that must interact with one another in a specific manner, for example, they require accelerators to cure. Furthermore, the agents require special storing conditions, for example, an environment free from moisture, to prevent premature curing. Finally, the release agents that include organic solvents are not environmentally friendly and must be carefully disposed.

### SUMMARY OF THE INVENTION

The aforementioned problems are overcome in the present invention wherein a water-soluble, release composition including a siloxane polymer is applied to a pre-shaped article before shaping or molding the article to improve the release of the article from shape determining surfaces. Because the release composition is water-soluble, it is easily washed from the article after its use in shaping or molding process, or from the shape determining surfaces of a mold or mandrel when these surfaces are coated.

In one embodiment, the siloxane polymer is a water-soluble dimethicone copolyol that does not require curing after application. This dimethicone copolyol may include a polyoxyethylene and/or polyoxypropylene side chain to improve the release characteristics of the composition. The dimethicone copolyol also may be combined with water in a mixture to form the release composition.

In another embodiment, the siloxane polymer is used in a molding or shaping process, including the steps of: applying the siloxane polymer to a shaping surface or a pre-shaped article; positioning the pre-shaped article adjacent the shaping surface; and shaping the article. Optionally, after shaping an article, the siloxane polymer is washed from its surface, and the siloxane polymer is applied to the next article and/or shape determining surface before the next article is shaped.

With the water-soluble, siloxane polymer-based release composition of the present invention, it is possible to produce more shaped articles with fewer defects in a shorter amount of time than with past release agents. This is because the release composition need not cure after the release composition is applied to a surface, before taking subsequent steps. Additionally, with the release composition of the present invention, shaped rubber hoses were found to be more readily removable from shape determining surfaces than hoses shaped with conventional release agents because the siloxane polymer-based release composition reduces the adhesion of shaped rubber articles to those surfaces. Moreover, with reduced adhesion, fewer defects occur in shaped articles. Furthermore, the siloxane polymer release composition is easily washed from surfaces with water. Also, the siloxane polymer of the present invention is environmentally friendly, and thus may be easily disposed of.

These and other objects, advantages, and features of the invention will be more fully understood and appreciated by reference to the detailed description of the invention.

### DETAILED DESCRIPTION OF THE INVENTION

I. Composition

A release composition used in accordance with the one embodiment of the present invention comprises a polymer having a backbone of silicone and oxygen, for example, a siloxane polymer, more particularly, a dimethicone copolyol, which preferably is soluble or miscible in water, alcohol and hydroalcoholic systems. As used herein, a “release composition” is any composition that facilitates the release of a molded or shaped article from the shape determining surfaces of a mold, a mandrel or other apparatus used to form an article in a desired configuration. “Miscible” means that the release composition disperses in a liquid. “Soluble” means that the release composition is able to blend uniformly and become one with a liquid.

Dimethicone copolyol, as used herein, is represented by the general formula:

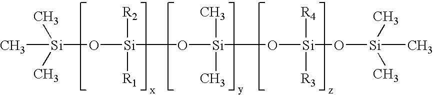

Wherein R₁ and R₂ are selected from: —CH₃, —H, or —O (—CH₂—CH₂—O)ₙ—CH₂—CH₃ (ethylene oxide); R₃ and R₄ are selected from: —CH₃, —H, or —O (—CH₂—CH₂—CH₂—O)ₘ—CH₂—CH₂—CH₃ (propylene oxide); m and n each are real number averages of integers from 1 to 50; each of m and n independently preferably is at least about 3, more preferably at least about 10; each of m and n independently is preferably less than about 30, more preferably not more than about 18; wherein each of x, y, and z are independently real number averages of integers from about 0 to about 1000; wherein the ratio of x to z is from about 10:1 to about 1:10; wherein, if y=0 then the ratio of x to z may be from about 50:1 to about 1:50; wherein x+y+z is more than about 20, preferably more than about 50; wherein x+y+z is preferably not more than about 1000, more preferably not more than 600, most preferably not more than about 400; independently, x and z are preferably at least about 10; more preferably in the range of about 5 to about 50, even more preferably about 10 to about 30; independently, x and z are preferably not more than about 200, preferably not more than about 50; independently y is preferably at least about 10, more preferably in the range of about 5 to about 50, even more preferably about 10 to about 40.

In another embodiment, the dimethicone copolyol of the release composition is a polymer of dimethylsiloxane with (a) a polyoxyethylene side chains at R1 and/or R2, and/or (b) polyoxypropylene side chains at R3 and/or R4. Optionally, the dimethicone copolyol includes at least one of an ethylene oxide side chain and a propylene oxide side chain, in any of the R₁-R₄ group positions.

Specific dimethicone copolyols suitable in the release composition of the present invention are dimethylsiloxane methyl(polyoxyethylene)siloxane copolymers and dimethylsiloxane methyl(polyoxyethylene polyoxypropylene) siloxane copolymer, as named under the Japanese Standards of Cosmetic Ingredients (“JCIC”).

Suitable dimethicone copolyols for the release composition of the present invention are available under a variety of trade names, including: Dow Corning 190 Surfactant, Dow Corning 193 Surfactant, Dow Corning 190 Fluid, Silicone 190 Surfactant, Silicone 193 Surfactant, Q2-5247 Fluid (all available from Dow Corning of Midland, Mich.); Silicone L-720, Silicone L-722, Silicone L-7002, Silicone L-7500, Silicone L-7600 Surfactant (all available from Dow Chemical of Midland, Mich.); Rhodorsil Oils 70646 (available from Rhone Poulenc of Paris, France); and Silicone Copolymer F-754 (available from SWS Silicones of Adrian, Mich.). Most of these commercially available dimethicone copolyols are components of cosmetic and personal care products, for example, hair spray, skin care lotions, and perfumes. Not until the unexpected discovery disclosed herein was the usefulness of these dimethicone copolyols in manufacturing processes, such as shaping, realized.

The release composition may include dimethicone copolyols mixed with water. Water may be present in amounts from about 85% to about 0% water. The release properties improve when the water content is about 70% or less, preferably about 60% or less, and more preferably about 50% or less. Dimethicone copolyol may be present in water/dimethicone copolyol containing compositions in amounts of not more than about 100%, preferably not more than about 80%, more preferably not more than about 70%, even more preferably not more than 50%. Alternatively, the dimethicone copolyol is preferably present in amounts of at least about 18%, more preferably at least about 25% and even more preferably at least about 30%. And optionally, the ratio of dimethicone copolyol to water is from about 1:1 to about 3:1.

The dimethicone copolyol used in the release composition of the present invention may have a variety of end blocks and/or end caps. Suitable end blocks and/or caps include, but are not limited to, trimethylsiloxy units, trimethylsilicone, hydroxy units and acetoxy units.

The release composition optionally is substantially free of volatile solvents to reduce the impact of the composition on the environment when removed from a surface or article or released via evaporation into the air. By substantially free, it is meant that the composition includes less than about 1% by weight volatile solvents. Volatile solvents include, for example, hydrocarbon solvents, mineral spirit solvents, toluene, xylene and cyclohexane.

The release composition of the present invention is aqueous, however, the composition also may be in gel, solid or other form. Optionally, the release composition may include a colorant to aid in application to surfaces, or additional components that do not interfere with the manufacture of the composition or its use as a release agent.

II. Method of Use

A method of using the release composition of the present invention will now be described in connection with shaping a pre-shaped article to a desired shape with shape determining surfaces of a mold and/or mandrel. As used herein, the term “pre-shaped article” refers to an article before it is shaped with the shaping surface, and includes but is not limited to, an article in a standard configuration, for example a straight hose; an article in a molten form, for example molten elastomers or thermoplastics; and an article in a bulk state, for example pelletized thermoplastics. Additionally, the term “shaping” refers to any process that shapes an article, including but not limited to transfer molding, compression molding, injection molding, blow molding and mandrel forming.

Generally, the release composition described above is applied to one or more of the shaping surfaces of the mandrel/mold and/or the pre-shaped article. The pre-shaped article is positioned on or adjacent the shaping surfaces, and shaped with those surfaces. This may be done immediately after the application step, because little or no cure time is required for the release composition. As used herein, “adjacent” includes “contacting.” The shaped article is then removed from the shaping surfaces. The shaped article may be washed of remaining release composition if desired by the end user with a liquid.

In a specific embodiment, the release composition is used to form rubber hoses with a mandrel, however, the method described also is suitable for shaping and molding a variety of other products with mandrels, molds, combinations thereof and other shaping apparatus, collectively referred to herein as mandrel/mold. In one step, the above-described release composition is applied to the shape-determining surface of the mandrel/mold and pre-shaped hose. The release coating of the present invention may be applied with any suitable method such as brushing, rolling or dipping.

In another step, the treated hose is placed on the mandrel by hand force. Optionally, a secondary mold is positioned adjacent the hose and/or the mandrel to shape the hose in a desired configuration. The pre-shaped hose may be positioned on the mandrel preferably less than about 10 minutes after application of the release composition, more preferably less than about 5 minutes after application of the release composition, and most preferably after less than about 1 minute after application of the release composition. Moreover, the release composition does not require the application of heat to cure the composition before the article to undergoes shaping. For example, the release composition may be applied to a pre-shaped article at room temperature, and the article may be placed immediately on a mandrel. In such applications, the release composition may be referred to as a “no-cure” release composition. More specifically, as used herein, “no-cure” describes a material used to facilitate release in a shaping process, where the material does not require curing, for example physical, chemical and/or thermal transformation, before the material is interposed between a shaping surface and a pre-shaped article.

In yet another step, the combination of the hose and mandrel is placed in an oven for shaping of the hose and curing of the rubber from which is constructed. In one embodiment, the hose is shaped, also referred to as “cured” herein, in the oven for a period and temperature of preferably about 5 to about 60 minutes at a temperature of about 200° F. to about 400° F.; more preferably about 15 to about 40 minutes at a temperature of about 280° F. to about 325° F.; and most preferably about 10 to about 30 minutes.

After the hose is shaped, it is removed from the oven, as well as the mandrel and optionally any mold that is used. The removal is greatly facilitated because it is believed that the release composition prevents the rubber from adhering to the mandrel and/or mold even under the aggressive chemical, thermally-driven shaping process.

Where the release composition is water-soluble, the composition preferably is washed from the surface of the shaped hose with water. Other liquids may be used to wash the release composition from surfaces including but not limited to alcohol and glycol. Where the release composition is a non-toxic dimethicone copolyol, the composition may be discharged into a local municipal wastewater treatment system, within amounts allowed by law.

The release composition of the present invention may be used to facilitate the release of articles constructed from a variety of materials. The composition exhibits exceptional releasing ability when used to release theremoplastic elastomers, for example, rubber compositions including: natural rubber; butyl rubber; butyl-type rubber from a co-polymer of isoprene and isobutylene; modified butyl rubber, such as halogen substituted butyl rubbers, such as chlorobutyl rubber or bromobutyl rubber; EDPM (ethylene-propylene diene terpolymer); rubbers manufactured under the tradename Kraton by Shell Chemical Co.; nitrile rubber; reclaimed rubber; styrene butadiene rubber; butadiene rubber; polysulfide rubber; epichlorohydrin rubber elastomer; ethylene propylene copolymer; chlorinated polyethylene; chlorosulfonated polyethylene; silicone rubber; fluorosilicone rubber; fluorocarbon rubber and blends thereof. The release composition optionally may be used in connection with articles made from other materials including thermoplastics, silicone-based materials, urethane, neoprene, or other synthetic elastomers.

Many products may be shaped using the release compositions of the present invention. Exemplary products include tires, inner tubes, hoses of all shapes and configurations, shock absorbing products, reinforced belting such as automotive serpentine belts, soles for athletic shoes, plastic housings, automotive trim and accessories, industrial equipment parts, and the like.

### III. EXAMPLES

The following examples are illustrative only and should not be construed as limiting the invention. All parts, percentages and ratios are by weight unless otherwise indicated.

### A. Example 1

A straight fuel hose for an automobile was shaped to include a right angle bend having a radius of about one centimeter using the release composition of the present invention. The release composition was a solution of 50% water and the balance a dimethicone copolyol according to the above formula, wherein: R₁ is —CH₃; R₂ is ethylene oxide and n is 18; R₃ is —CH₃; R₄ is propylene oxide and m is 18; x is 12; y is 35; and z is 12.

A metal, shape-determining mandrel having the desired shaping surfaces was provided.

A hose comprising epichlorohydrin rubber having an outer diameter of 75 millimeters and inner diameter of 40 millimeters was cut to a desired length. An end of the hose was dipped in the release composition to thoroughly wet the interior of the hose at the dipped end with the composition. The hose was forced by hand onto the mandrel, wetted end first. It was observed that as the end was forced onto the mandrel, the release composition was transferred to the mandrel along its length, and subsequently disposed between the mandrel and the hose interior. The hose and mandrel were placed in a vulcanizing autoclave at 170° C. for ¼ hour and then removed from the autoclave. The hose was readily removed from the shaping surfaces of the mandrel without adhesion. The mandrel was inspected and no remnants of the hose were evident on the shaping surfaces. Within eight hours, 24 hoses were shaped, with zero quality defects. Each new hose was wetted with the release composition before shaping.

### B. Example 2

A straight hose according to Example 1 was attached to the mandrel of Example 1 by hand force. No release composition was used to wet the mandrel or the hose. The hose and mandrel were placed in a vulcanizing autoclave at 170° C. for ¼ hour and then removed from the autoclave. The hose adhered to the shaping surface and had to be cut and scraped from the mandrel.

### C. Example 3

A straight hose according to Example 1 was wetted with an oleic acid soap and applied to a mandrel wetted with the same by hand force. The hose was vulcanized as in Example 1. Within eight hours, 20 hoses were shaped, each time repeating the steps above. 10% of the shaped hoses were rejected because of damage to the hose surfaces caused by removal of the hose from the mandrel shaping surfaces. 90% of the vulcanized hoses were acceptable.

### D. Example 4

A straight hose according to Example 1 was wetted with butanol composition and was applied to a mandrel wetted with the same by hand force. The butanol composition included butanol alkoxylated with polypropylene oxide and polyethylene oxide in a ratio of 1:0.73, having a molecular weight of 4000, and diluted with water in a ratio of 1:1. The hose was vulcanized as in Example 1. Within eight hours, 22 hoses were shaped, each time, repeating the steps above. 50% of the shaped hoses were rejected because of damage to the hose surfaces caused by removal of the hose from the mandrel and mold surfaces. 50% of the vulcanized hoses were acceptable.

The above descriptions are those of certain embodiments of the invention. Various alterations and changes can be made without departing from the spirit and broader aspects of the invention as defined in the claims, which are to be interpreted in accordance with the principles of patent law, including the doctrine of equivalents. Except in the claims and the specific examples, or where otherwise expressly indicated, all numerical quantities in this description indicating amounts of material, reaction conditions, use conditions, and the like, are to be understood as modified by the word “about” in describing the broadest scope of the invention. Unless otherwise stated, all parts and percentages are by weight. Any reference to an item in the disclosure or to an element in the claim in the singular using the articles “a,” “an,” “the,” or “said” is not to be construed as limiting the item or element to the singular unless expressly so stated.

The embodiments of the invention in which an exclusive property or privilege is claimed are defined as follows:

1. A release composition for use in coating a shape determining surface of at least one of a mold and a mandrel comprising a polymer having a backbone of silicone and oxygen, said polymer having properties of at least one of water-solubility and water-miscibility.

2. The release composition of claim 1 wherein the polymer is dimethicone copolyol.

3. The release composition of claim 1 wherein the dimethicone copolyol includes at least one of a polyoxyethylene side chain and a polyoxypropylene side chain.

4. The release composition of claim 1 wherein the dimethicone copolyol includes at least one of an ethylene oxide side chain and a propylene oxide side chain.

5. The release composition of claim 1 further comprising about 0% to about 70% water, with the balance substantially only dimethicone copolyol.

6. The release composition of claim 1 further comprising water, wherein the ratio of dimethicone copolyol to water is from about 1:1 to about 3:1.

7. The release composition of claim 1 wherein the dimethicone copolyol comprises at least about 18% of the composition.

8. The release composition of claim 1 wherein the dimethicone copolyol comprises at least about 25% of the composition.

9. The release composition of claim 1 wherein the dimethicone copolyol comprises at least about 50% of the composition.

10. A release composition for use in coating a shape determining surface of at least one of a mold and a mandrel comprising dimethicone copolyol having a side chain of at least one of polyoxyethylene and polyoxylpropylene.

11. A method of shaping an article comprising:
applying a release composition comprising dimethicone copolyol to at least one of a shaping surface and a pre-shaped article;
positioning the pre-shaped article in proximity to the shaping surface; and
shaping the article.

12. The method of claim 11 wherein the dimethicone copolyol exhibits properties of at least one of water-solubility and water-miscibility, and the composition further comprises water mixed with the dimethicone copolyol.

13. The method of claim 11 wherein the release composition is applied to the pre-shaped article.

14. The method of claim 11 comprising washing the release composition from the article with at lease one of water, alcohol and glycol.

15. The method of claim 11 wherein the release composition comprises at least about 18% dimethicone copolyol.

16. The method of claim 11 wherein the pre-shaped article is positioned on the mandrel in less than about five minutes after said applying step.

17. The method of claim 11 wherein the dimethicone copolyol includes at least one of a polyoxyethylene side chain and a polyoxypropylene side chain.

18. The method of claim 11 wherein the dimethicone copolyol is a polymer including a functional group of at least one of ethylene oxide and propylene oxide.

19. A method of shaping an article on a shape determining surface comprising:
applying a release composition comprising dimethicone copolyol to at least one of the shape determining surface and the article;
shaping the article to a desired shape with the shape determining surface;
washing the release composition from at least one of the shape determining surface and the article with a liquid.

20. The method of claim 19 wherein the liquid is selected from the group consisting of water, alcohol and glycol.
